(19) United States
(12) Patent Application Publication
(10) Pub. No.: US 2021/0192049 A1
(43) Pub. Date: Jun. 24, 2021

(54) ELECTRONIC DEVICE AND METHOD OF UPDATING SOFTWARE

(71) Applicant: REALTEK SEMICONDUCTOR CORPORATION, HSINCHU (TW)

(72) Inventors: HAI-CHAO ZHENG, Yueqing City (CN); SHIH-CHIN CHI, Taichung City (TW); HAO-CHENG WU, Hsinchu City (TW); CHANG-HUNG WU, Hsinchu City (TW); NENG-HSIEN LIN, Kaohsiung City (TW); WEI-XIN HUANG, Hsinchu County (TW)

(21) Appl. No.: 17/126,241

(22) Filed: Dec. 18, 2020

(30) Foreign Application Priority Data
Dec. 23, 2019 (CN) 201911336759.6

(51) Int. Cl. G06F 21/57; G06F 8/65; H04L 9/32; H04L 9/08

(52) U.S. Cl. CPC G06F 21/572; H04L 9/0825; H04L 9/3247; G06F 8/65

(57) ABSTRACT

An electronic device includes a first memory circuit, a second memory circuit, and a processor circuit. The first memory circuit is configured to store a key. The second memory circuit is configured to store an original software. The processor circuit is configured to receive data for updating, in which the data for updating includes a software for updating and a digital signature; perform a digest algorithm to process the software for updating and generate a first digest; utilize the key to decrypt the digital signature and generate a second digest; and compare the first digest with the second digest, in order to determine whether to update the original software to become the software for updating.

### BACKGROUND OF THE INVENTION

### 1. Field of the Invention

The present disclosure relates to a method of updating software, especially to a method and an electronic device that utilize data encryption/decryption and a digital signature to update the software.

### 2. Description of Related Art

In embedded system applications, it is important to develop software according to requirements of a client. In current approaches of updating software, multiple validations (e.g., parity check, redundancy check, etc.) are utilized to detect whether a data transmission error exists in the course of updating software, in order to ensure that the software can be correctly updated. However, these validations cannot detect whether the software is maliciously tampered by a third party, which puts the client device at certain risk.

### SUMMARY OF THE INVENTION

In some embodiments, an electronic device includes a first memory circuit, a second memory circuit, and a processor circuit. The first memory circuit is configured to store a key. The second memory circuit is configured to store an original software. The processor circuit is configured to receive data for updating, in which the data for updating includes a software for updating and a digital signature; perform a digest algorithm to process the software for updating and generate a first digest; utilize the key to decrypt the digital signature and generate a second digest; and determine whether to update the original software to become the software for updating according to a comparison of the first digest and the second digest.

In some embodiments, a method of updating software includes the following operations: receiving data for updating, in which the data for updating includes a software for updating and a digital signature; performing a digest algorithm to process the software for updating, in order to generate a first digest; utilizing a public key to decrypt the digital signature, in order to generate a second digest; and determining whether to update an original software to become the software for updating according to a comparison of the first digest and the second digest.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1A illustrates a flow chart of a method of updating software according to some embodiments of the present disclosure.

FIG. 1B illustrates a schematic diagram of data processing in various operations of FIG. 1A according to some embodiments of the present disclosure.

FIG. 2 is a schematic diagram of an electronic device according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “circuit” may indicate an object, which is formed with one or more transistors and/or one or more active/passive elements based on a specific arrangement, for processing signals. As used herein, the term “and/or” includes any and all combinations of one or more of the associated listed items.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments.

In some embodiments, terms “digest,” “key,” “software,” and “digital signature” may indicate various digital electronic data. Without departing the scope of embodiments of present disclosure, the above terms may be not limited to the digital electronic data.

For ease of understanding, like elements in various figures are designated with the same reference numbers.

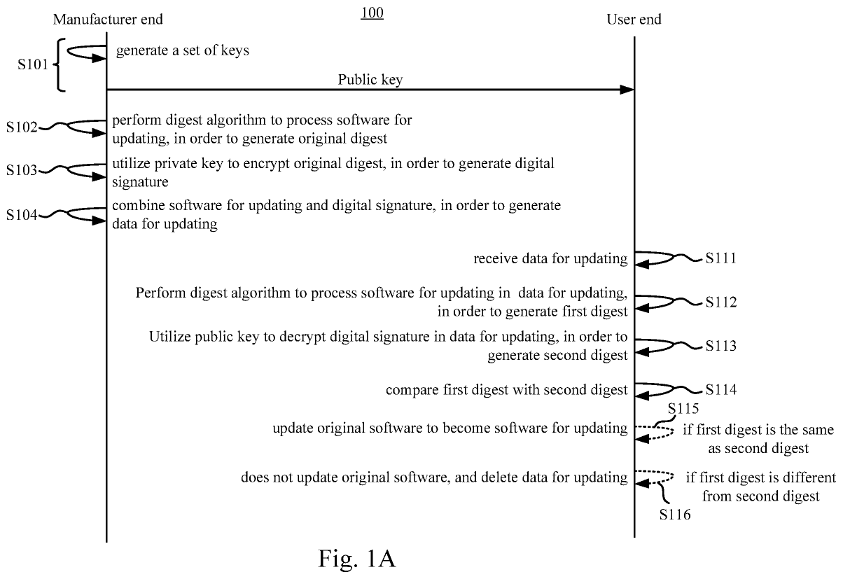

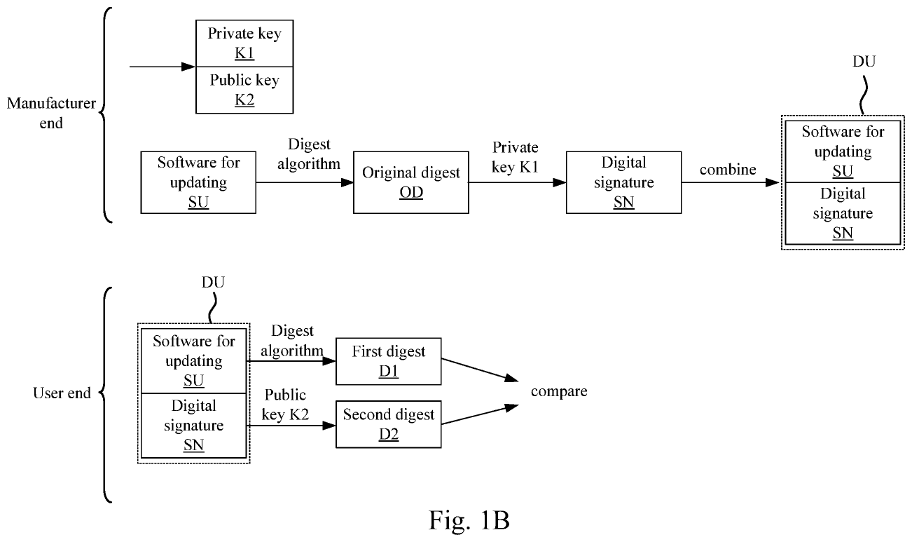

FIG. 1A illustrates a flow chart of a method 100 of updating software according to some embodiments of the present disclosure. FIG. 1B illustrates a schematic diagram of data processing in various operations of FIG. 1A according to some embodiments of the present disclosure. For ease of understanding, operations of the method 100 are described with reference to FIG. 1A and FIG. 1B.

In operation S101, a manufacturer end generates a set of keys, and stores a public key in the set of keys to a user end.

For example, as shown in FIG. 1B, the manufacturer end (which may be a computer device, sever, or the like of a manufacturer) generates a random set of keys which includes a private key K1 and a public key K2 that correspond to each other. In some embodiments, the manufacturer end randomly generates the private key K1, and utilizes the private key K1 to perform an elliptic curve cryptography algorithm, in order to generate the public key K2. In some embodiments, the private key K1 and the public key K2 may be (but not limited to) a set of asymmetric keys. The generation and the type of the private key K1 and the public key K2 are given for illustrative purposes, and the present disclosure is not limited thereto. Various types and generations of the private key and the public key are within the contemplated scope of the present disclosure.

In operation S102, the manufacturer end performs a digest algorithm to process software for updating, in order to generate an original digest.

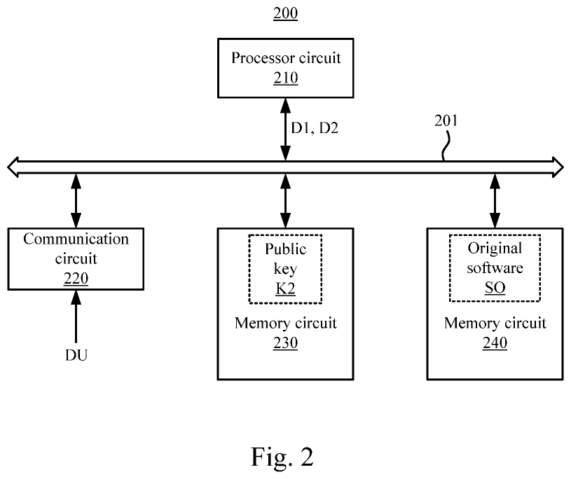

For example, as shown in FIG. 1B, the manufacturer end performs the digest algorithm to process software SU for updating, in order to generate an original digest OD. In other words, the software SU for updating is a message to be processed by the digest algorithm. In some embodiments, the software SU for updating may be an application program to be updated to an electronic device 200 in FIG. 2. For example, the software SU for updating may be (but not limited to) firmware, operating system, driver(s), boot loader, or application(s). In some embodiments, the digest algorithm may be a hash function. For example, the digest algorithm may be a message digest (MD) algorithm, a secure hash algorithm (SHA), or the like. The above types of the digest algorithm are given for illustrative purposes, and the present disclosure is not limited thereto.

In operation S103, the manufacturer end utilizes the private key to encrypt the original digest, in order to generate a digital signature. In operation S104, the manufacturer end combines the software for updating and the digital signature to generate data for updating.

For example, as shown in FIG. 1B, the manufacturer end utilizes the private key K1 to encrypt the original digest OD, in order to generate a digital signature SN. Afterwards, the manufacturer end combines the software SU for updating and the digital signature SN, in order to generate data DU for updating. In some embodiments, the manufacturer end attaches the digital signature SN to the software SU for updating, and outputs the software SU for updating and the digital signature SN as the data DU for updating.

In operation S111, the user end receives the data for updating. In operation S112, the user end performs a digest algorithm to process the software for updating in the data for updating, in order to generate a first digest. In operation S113, the user end utilizes the public key to decrypt the digital signature in the data for updating, in order to generate a second digest.

For example, the user end (e.g., electronic device 200 in FIG. 2) may be connected with the manufacturer end via a network (or various data transmission media), in order to acquire the data DU for updating. The user end may perform the digest algorithm to process the software SU for updating in the data DU for updating, in order to generate a first digest D1. The user end may utilize the public key K2 which is stored in advance to decrypt the digital signature SN, in order to generate a second digest D2. In some embodiments, the digest algorithm performed in operation S102 is the same to that performed in operation S112. As a result, if the data DU for updating is not tampered and is transmitted intact to the user end, the first digest D1 is the same as the original digest OD.

In operation S114, the first digest is compared with the second digest. In operation S115, if the first digest is the same as the second digest, the original software is updated to become the software for updating. In operation S116, if the first digest is different from the second digest, the original software is not updated to become the software for updating, and the data for updating is deleted.

As mentioned above, under the condition that the manufacture end and the user end utilize the same digest algorithm, if the data DU for updating is not tampered and is transmitted intact to the user end, the first digest D1 is the same as the original digest OD. If the data DU for updating is not tampered and is transmitted intact to the user end, the second digest D2 obtained by the user end is also the same as the original digest OD. Accordingly, the user end is able to compare the first digest D1 with the second digest D2, in order to determine whether the data DU for updating is tampered and/or whether the intact data DU for updating is received.

If the first digest D1 is the same as the second digest D2, it indicates that the data DU for updating is valid (e.g., the data is not tampered and the data integrity is correct). Under this condition, the user end updates the original software to become the software SU for updating. Alternatively, if the first digest D1 is different from the second digest D2, it indicates that the data DU for updating is invalid (e.g., the data may be tampered and/or the data integrity may be incorrect). Under this condition, the user end does not update the original software to become the software SU for updating, and deletes the received data DU for updating.

With the above operations, it is ensured that the software having the eligible authenticity and the eligible validity is correctly provided to a software updated process, in order to improve the system security of electronic device(s) of the user end.

In some embodiments, the algorithm using the private key K1 or the public key K2 to perform the encryption/decryption may be a hash function. In some embodiments, the algorithm using the private key K1 or the public key K2 to perform the encryption/decryption may be an asymmetric encryption/decryption algorithm, but the present disclosure is not limited thereto.

In some embodiments, the manufacturer end may include one or more manufacturers. For example, the manufacturer end includes a first manufacturer and a second manufacturer. The first manufacturer manufactures one or more circuits in a device of the user end, and is able to perform operation S101. The second manufacturer is a program developer, and is able to perform operations S102-S104. In some embodiments, the first manufacturer and the second manufacturer may be different departments in a company. The above examples of the manufacturer end are given for illustrative purposes, and the present disclosure is not limited thereto.

The above description of the method 100 of updating software includes exemplary operations, but the operations of the method 100 of updating software are not necessarily performed in the order described above. The order of the operations of the method 100 of updating software can be changed, or the operations can be executed simultaneously or partially simultaneously as appropriate, in accordance with the spirit and scope of various embodiments of the present disclosure.

FIG. 2 is a schematic diagram of an electronic device 200 according to some embodiments of the present disclosure. In some embodiments, the electronic device 200 may be an embedded system. In some embodiments, the electronic device 200 may be an application specific integrated circuit. In some embodiments, the electronic device 200 is a device of the user end in FIG. 1A and FIG. 1B.

The electronic device 200 includes a processor circuit 210, a communication circuit 220, a memory circuit 230, and a memory circuit 240. The processor circuit 210 may be a processor circuit that has a computing ability and/or an ability of executing program(s). For example, the processor circuit 210 may be a micro-processor circuit, a micro-controller circuit, a central processor circuit, a digital signal processor circuit, etc. The processor circuit 210 is configured to perform operations S111-S116 of the user end in FIG. 1A and FIG. 1B, in order to determine whether to update the software. The processor circuit 210 is coupled to the communication circuit 220, the memory circuit 230, and the memory circuit 240 via a transmission media 201. In some embodiments, the transmission media 201 is a data bus.

The processor circuit 210 receives the data DU for updating from the manufacturer end via the communication circuit 220. In some embodiments, the communication circuit 220 may a network application circuit (e.g., an Ethernet network card device). In some embodiments, the communication circuit 220 may be a data transmission interface circuit (e.g., a USB interface circuit). The memory circuit 230 is configured to store a key (e.g., the public key K2 in FIG. 1B). In some embodiments, the memory circuit 230 may be implemented with a one-time programmable (OTP) memory, in order to improve the security of the public key K2. In some embodiments, the memory circuit 230 may be implemented with an eFuse circuit.

In some embodiments, the memory circuit 240 is configured to be store original software SO. The original software SO may be software that is stored by the electronic device 200 in advance. For example, the original software SO may be (but not limited to) an operating system, a driver, a boot loader, or an application program. After the processor circuit 210 performs operation S111 to S114 in FIG. 1A, the processor circuit 210 is able to determine whether to update the original software SO to become the software SU for updating in FIG. 1B. For example, when the first digest D1 is the same as the second digest D2, the processor circuit 210 updates the original software SO to become the software SU for updating (i.e., operation S115). Alternatively, when the first digest D1 is different from the second digest D2, the processor circuit 210 does not update the original software SO to become the software SU for updating, and deletes the received data DU for updating (i.e., operation S116). In some embodiments, the memory circuit 240 may be implemented with a flash memory, but the present disclosure is not limited thereto. In some embodiments, the memory circuit 230 and the memory circuit 240 may be integrated as one memory.

The above arrangements of the electronic device 200 are given for illustrative purposes, and the present disclosure is not limited thereto. Various electronic devices able to be applied with the method 100 of updating software are within the contemplated scope of the present disclosure.

As described above, the method of updating software and the electronic device provided in some embodiments of the present disclosure are able to utilize the digest and the digital signature to ensure that the authenticity and the validity of the software are eligible, in order to improve the system security of the electronic device.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. An electronic device, comprising:
a first memory circuit configured to store a key;
a second memory circuit configured to store an original software; and
a processor circuit configured to:
receive data for updating that include a software for updating and a digital signature;
perform a digest algorithm to process the software for updating and generate a first digest;
utilize the key to decrypt the digital signature and generate a second digest; and
determine whether to update the original software to become the software for updating according to a comparison of the first digest and the second digest.

2. The electronic device of claim 1, wherein if the first digest is the same as the second digest, the processor circuit is further configured to update the original software to become the software for updating.

3. The electronic device of claim 1, wherein if the first digest is different from the second digest, the processor circuit does not update the original software to become the software for updating, and deletes the data for updating.

4. The electronic device of claim 1, wherein the digital signature is generated based on a private key and an original digest corresponding to the software for updating.

5. The electronic device of claim 4, wherein the original digest is generated by performing the digest algorithm to process the software for updating.

6. The electronic device of claim 4, wherein the key is a public key corresponding to the private key.

7. A method of updating software, comprising:
receiving data for updating that include a software for updating and a digital signature;
performing a digest algorithm to process the software for updating, in order to generate a first digest;
utilizing a public key to decrypt the digital signature, in order to generate a second digest; and
determining whether to update an original software to become the software for updating according to a comparison of the first digest with the second digest.

8. The method of claim 7, further comprising:
performing the digest algorithm to process the software for updating, in order to generate an original digest;
utilizing a private key to encrypt the original digest, in order to generate the digital signature, wherein the private key corresponds to the public key; and
combining the original digest and the digital signature, in order to generate the data for updating.

9. The method of claim 7, further comprising:
if the first digest is the same as the second digest, updating the original software to become the software for updating.

10. The method of claim 7, wherein if the first digest is different from the second digest, the original software is not updated to become the software for updating.
